(19) United States
(12) Patent Application Publication
(10) Pub. No.: US 2025/0278171 A1
(43) Pub. Date: Sep. 4, 2025

(54) NON-TRANSITORY COMPUTER-READABLE STORAGE MEDIUM STORING PROGRAM, DISPLAY DEVICE, AND DISPLAY METHOD

(71) Applicant: SEIKO EPSON CORPORATION, Tokyo (JP)

(72) Inventor: Yusuke YAMADA, SHIOJIRI-SHI (JP)

(21) Appl. No.: 19/065,447

(22) Filed: Feb. 27, 2025

(30) Foreign Application Priority Data
Mar. 1, 2024 (JP) 2024-031078

(51) Int. Cl. G06F 3/0483; G06F 3/04817; G06F 3/0482

(52) U.S. Cl. CPC G06F 3/0483; G06F 3/04817; G06F 3/0482

(57) ABSTRACT

A non-transitory computer-readable storage medium storing a program is provided, the program causing a computer to function as: a display processing unit that displays a plurality of pages included in a document in a first state on a display unit, based on original image data, and displays a plurality of pages included in a document in a second state on the display unit, based on reduced image data of each page; and a data management unit that, when a document present in a storage unit shifts from the first state to the second state, deletes the original image data of the shifted document from the storage unit while leaving the reduced image data of each page of the shifted document, and when the document present in the storage unit shifts from the second state to the first state, acquires the original image data of the shifted document from an external device.

The present application is based on, and claims priority from JP Application Serial Number 2024-031078, filed Mar. 1, 2024, the disclosure of which is hereby incorporated by reference herein in its entirety.

### BACKGROUND 1. Technical Field

The present disclosure relates to a non-transitory computer-readable storage medium storing a program, a display device, and a display method.

### 2. Related Art

According to the related art, a technique of displaying image data of a document is known. JP-A-2023-018734 discloses a technique of displaying a thumbnail image of each of a plurality of pages included in a document at a lower part of a display unit, specifying a page corresponding to one of the thumbnail images when this thumbnail image is selected, and displaying a page image of the specified page at an upper part of the display unit.

JP-A-2023-018734 is an example of the related art.

When a plurality of documents are stored in a device in order to display data of the plurality of documents, it is desired that the amount of data should be reduced.

### SUMMARY

According to an aspect of the present disclosure, a non-transitory computer-readable storage medium storing a program is provided, the program causing a computer to function as: a display processing unit that displays a plurality of pages included in a document in a first state on a display unit, based on original image data, and displays a plurality of pages included in a document in a second state on the display unit, based on reduced image data of each page; and a data management unit that, when a document present in a storage unit shifts from the first state to the second state, deletes the original image data of the shifted document from the storage unit while leaving the reduced image data of each page of the shifted document, and when the document present in the storage unit shifts from the second state to the first state, acquires the original image data of the shifted document from an external device.

According to another aspect of the present disclosure, a display device includes: a processor that causes a display unit to display a plurality of pages included in a document in a first state, based on original image data, and causes the display unit to display a plurality of pages included in a document in a second state, based on reduced image data; a communication unit that, in response to a shift of the document from the second state to the first state, acquires the original image data of the shifted document from an external device; and a storage unit that stores the original image data of the document in the first state and the reduced image data of each page of the document in the second state and does not store the original image data of the document in the second state, wherein the storage unit stores the original image data of the shifted document when the document shifts from the second state to the first state, and deletes the original image data of the shifted document when the document shifts from the first state to the second state.

According to another aspect of the present disclosure, a display method includes: causing a display unit to display a plurality of pages included in a document in a first state, based on original image data; causing the display unit to display a plurality of pages included in the document in a second state, based on reduced image data of each page; when the document shifts from the first state to the second state, deleting the original image data of the shifted document from the storage unit while leaving the reduced image data of each page of the shifted document; and when the document shifts from the second state to the first state, causing the storage unit to store the original image data of the shifted document.

### BRIEF DESCRIPTION OF THE DRAWINGS

FIG. 1 is a schematic diagram of a display system.

FIG. 2 shows the configuration of a display device.

FIG. 3 shows a display example displayed on a display unit.

FIG. 4 shows an example of the data structure of a document.

FIG. 5 is a flowchart showing display processing.

FIG. 6 is a flowchart showing detailed processing in enlarged display processing.

FIG. 7 illustrates an estimation condition.

FIG. 8 shows a display example of enlarged display.

FIG. 9 shows the data structure of a data set of a document including drawing image data.

FIG. 10 shows a display example according to a modification example.

### DESCRIPTION OF EMBODIMENTS

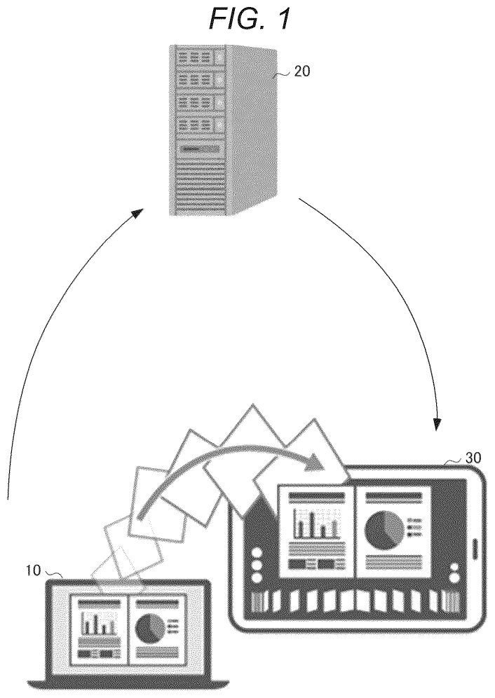

FIG. 1 is a schematic view of a display system 1 according to an embodiment. In the display system 1, a user transfers data which the user wants to view, from a user PC 10 carried by the user to a display device 30. The data is transferred via a display management server 20. The user PC 10, the display management server 20, and the display device 30 are connected via a network.

The user PC 10 is an information processing device used by the user. The display device 30 is a portable information processing device used by the user. The display device 30 may be, for example, a smartphone or a tablet terminal. The display device 30 receives data from the user PC 10 via the display management server 20 and displays the data. The display management server 20 manages data transmitted to the display device 30.

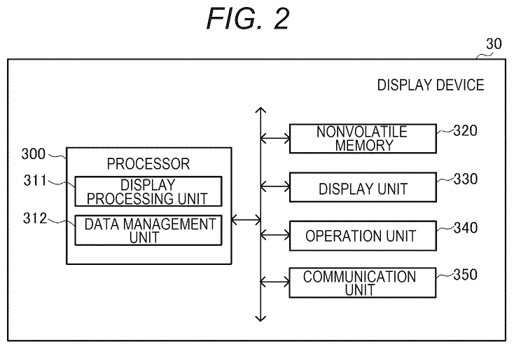

FIG. 2 shows the configuration of the display device 30. The display device 30 includes a processor 300, a nonvolatile memory 320, a display unit 330, an operation unit 340, and a communication unit 350. The processor 300 has a CPU, a ROM, and a RAM, and executes a program recorded in the ROM or the nonvolatile memory 320 and thus can control each part of the display device 30. The processor 300 may be configured with a single chip or may be configured with a plurality of chips. Also, for example, an ASIC may be employed instead of the CPU, or a configuration in which the CPU and the ASIC cooperate with each other may be employed. In the nonvolatile memory 320, the program executed by the processor 300 and data or the like are recorded.

The display unit 330 displays various information. The operation unit 340 accepts a user's operation. The operation unit 340 may be provided as unified with the display unit 330 in the form of a touch panel. The communication unit 350 is one or a plurality of antennas to perform wireless communication with an external device. The communication unit 350 may be a cable connector to perform wired communication with an external device. The antenna and the cable connector are also referred to as communication interfaces.

As described above, the display device 30 in the present embodiment receives data from the display management server 20 and displays the data on the display unit 330. However, when the amount of such data increases, the memory capacity becomes insufficient. Therefore, the display device 30 performs processing for reducing the amount of data. As a functional configuration for this purpose, the processor 300 includes a display processing unit 311 and a data management unit 312. The functions of the display processing unit 311 and the data management unit 312 are implemented by the processor 300 reading a program stored in the nonvolatile memory 320 and executing the program. That is, in the description below, the processing described as being executed by the display processing unit 311 and the data management unit 312 is the processing executed by the processor 300.

The display processing unit 311 performs processing related to the display of data on the display unit 330. The data management unit 312 performs processing related to data management such as storage and deletion of data to be displayed.

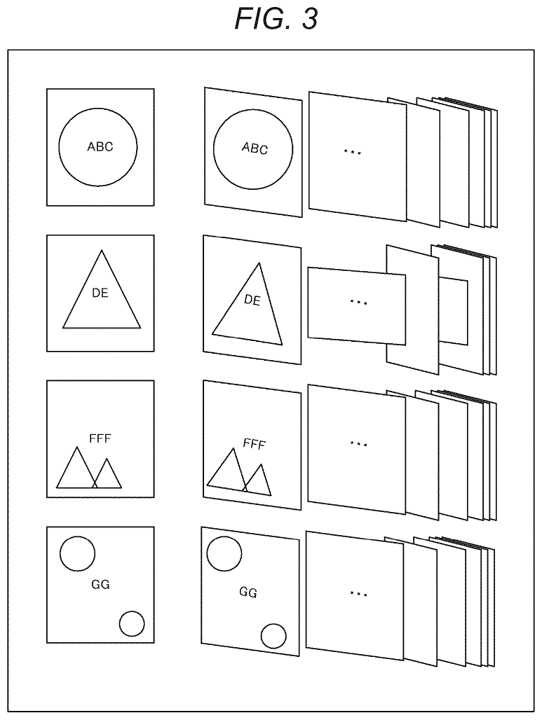

FIG. 3 shows a display example displayed on the display unit 330 by the display processing unit 311. In this way, a list of a plurality of documents stored in the display device 30 is displayed on the display unit 330. The documents include a text, an image, and the like. Each document has a plurality of pages, and each page is displayed. In this way, a plurality of pages of each document are displayed side by side simultaneously on one screen.

More specifically, the entire page of the first page is displayed, and the second page is displayed to the right of the first page, as the page following the first page. Similarly, the third and subsequent pages are displayed to the right of the previous page. Moreover, each page is displayed in a partly overlapping state, depending on the total number of pages included in the document. At this time, the pages are arranged in such a way that the area of the overlapping part increases as the pages proceed. Also, for each page, a reduced image in the state where the shape is maintained is displayed as an image of the page. For example, it is assumed that the first page of a document “DE” is a vertically long page and that the second page is a horizontally long page. In this case, the first page is shown in a vertically long shape and the second page is shown in a horizontally long shape, as shown in FIG. 3. Also, when the number of documents that can be displayed on one screen is, for example, four and five or more documents are stored, all these documents are displayed by scrolling.

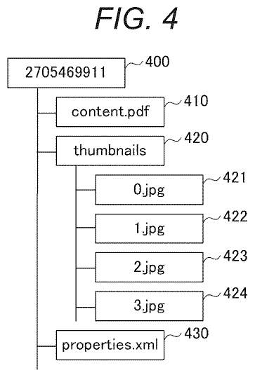

FIG. 4 shows the data structure of a document displayed on the display unit 330 by the display processing unit 311. One data set 400 corresponding to one document is stored. Identification information is given to the data set 400. The data set 400 includes original image data 410 of the document, a thumbnail data group 420, and metadata 430, which are transmitted from the user PC 10. The thumbnail data group 420 includes a plurality of thumbnail data 421 to 424 corresponding to respective pages included in the original image data 410. In the example shown in FIG. 4, the original image data 410 includes four pages, and the thumbnail data group 420 includes four thumbnail data 421 to 424 accordingly. The thumbnail data is an example of reduced image data. It is assumed that the thumbnail data group 420 is generated in the display management server 20, based on the original image data 410. In another example, the thumbnail data group 420 may be generated in the user PC 10.

The metadata 430 is information representing a characteristic of the document, and includes, for example, the shape such as the aspect ratio of each page, and information such as the total number of pages. The metadata 430 also includes secondary information related to an operation of the user, such as a page with a tag attached, the last page opened, a page that was last viewed (displayed as a default spread position), a page that is pulled up, and a page that is read from right to left or from left to right. This information can be reflected on the display of the page. For example, the tagged image can be superimposed and displayed on a page based on the original image data or a page based on the thumbnail data in accordance with the metadata. Also, for example, a part of the pages can be displayed as shifted in such a way that the page looks pulled up in accordance with the metadata.

The document data set 400 is stored in, for example, a document memory provided in the RAM. The display processing unit 311 displays the data of the document stored in the document memory, on the display unit 330. The document memory is an example of a storage unit.

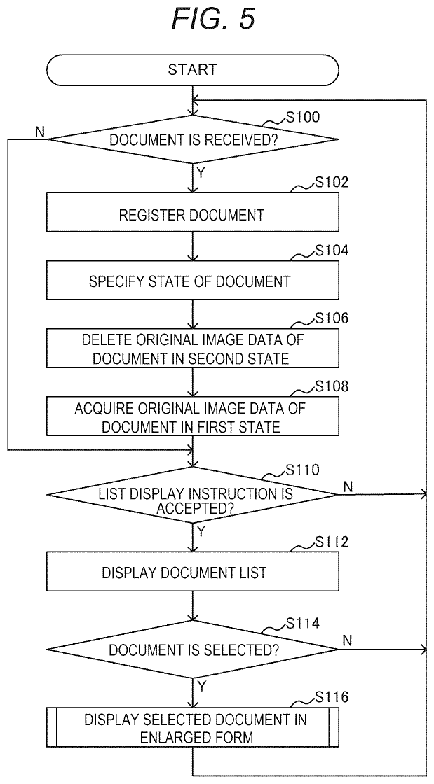

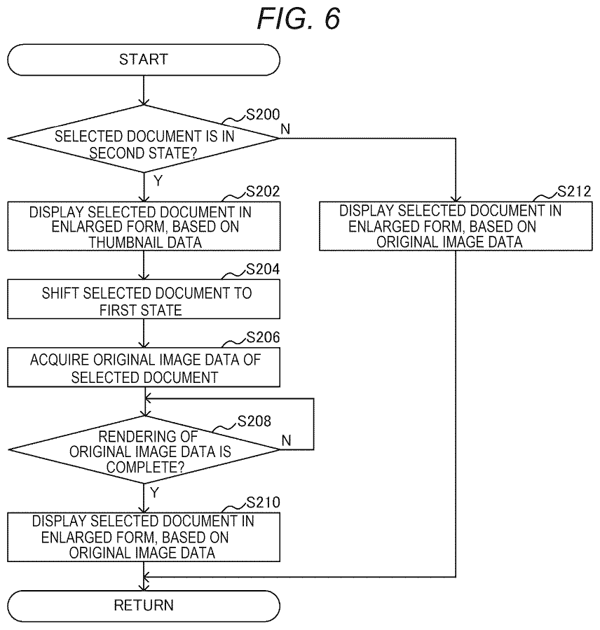

FIG. 5 is a flowchart showing display processing performed by the display device 30. FIG. 6 is a flowchart showing detailed processing in enlarged display processing. As illustrated in FIG. 5, upon receiving a display target document (data set) from the user PC 10 via the display management server 20 (Y in step S100), the data management unit 312 of the display device 30 registers the received document in the document memory (step S102). In this way, the data management unit 312 stores the original image data and the thumbnail data of the document in the storage unit and thus registers the document. The same data set is similarly registered in the display management server 20.

A plurality of documents may be registered in the document memory. When documents are registered without limitation, the amount of data increases and data cannot be stored in the document memory. Therefore, in the present embodiment, in the case of a document that is highly likely to be viewed by the user, the display device 30 deletes the original image data having a relatively large amount of data, of the data included in the data set, and leaves only the thumbnail data set and the metadata. Thus, the amount of data in the document memory can be prevented from becoming too large. Details of this processing will be described with reference to a flowchart. When the data management unit 312 does not receive a document (N in S100), the processing proceeds to S110.

After the processing of step S102, the data management unit 312 specifies the states of all the documents registered in the document memory (step S104). In the present embodiment, the state of the document includes a first state and a second state. The document selected by the user is in the first state. In addition, the document estimated to be more likely to be selected by the user than the document in the second state is also in the first state. In the present embodiment, the estimation condition of the likelihood of being selected by the user is set, and the document is specified as being in the first state when the estimation condition is satisfied, and the document is specified as being in the second state when the estimation condition is not satisfied. The document selected by the user satisfies the estimation condition. The estimation condition is, for example, a condition that the document is included in the top eight documents selected alternately from documents registered in the document memory at recent timings and documents selected by the user at recent timings.

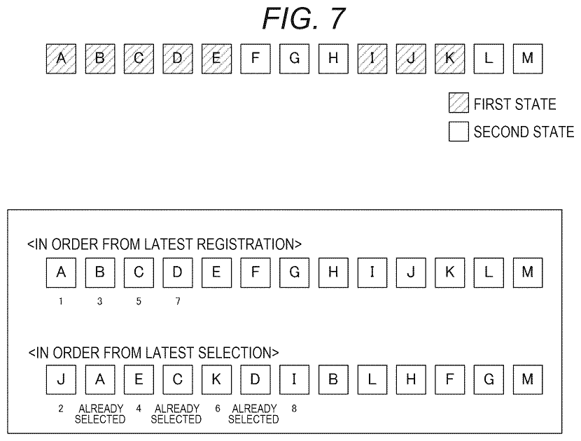

FIG. 7 illustrates the estimation condition. For example, 13 documents A to M are registered in the document memory, and the order from the latest registration (registration order) and the order from the latest selection (selection order) of these documents are as shown in FIG. 7.

In this case, the document A, which is the first in the registration order, is selected first, and the document J, which is the first in the selection order, is selected next by the data management unit 312. Subsequently, the document B, which is the second in the registration order, is selected. Next, the document A, which is the second in the selection order, is already selected, and therefore the subsequent third document E is selected. Next, the document C, which is the third in the registration order, is selected. Next, the document C, which is the fourth in the selection order, is already selected, and therefore the subsequent fifth document K is selected. Next, the document D, which is the fourth in the registration order, is selected. Next, the document D, which is the sixth in the selection order, is already selected, and therefore the subsequent seventh document I is selected. In this way, a total of eight documents are selected, and the states of these documents are specified as the first state. The remaining five documents are specified as being in the second state.

Referring back to FIG. 5, after the processing of step S104, the data management unit 312 deletes the original image data of each of the documents shifted to the second state (step S106). The document in the second state is considered less likely to be viewed by the user than the document in the first state. Therefore, in this way, the data management unit 312 deletes the original image data of the document in the second state that is less likely to be viewed. Even in this case, the data management unit 312 leaves the thumbnail and the metadata in the document memory in order to use the thumbnail and the metadata when displaying the document.

Next, the data management unit 312 acquires the original image data of the document shifted to the first state from the display management server 20 via the communication unit 350 and registers the original image data in the document memory (step S108). The data may be received from the display management server 20 on a per data set basis. In this case, the data management unit 312 receives the data set shifted to the first state, and updates the target data set with the received data set, that is, the data set including the original image data.

In this way, when the document present in the document memory shifts from the first state to the second state, the data management unit 312 deletes the original image data while leaving the thumbnail data of each page of the shifted document. When the document present in the document memory shifts from the second state to the first state, the data management unit 312 acquires the original image data of the shifted document from the display management server 20.

Next, the display processing unit 311 checks whether a list display instruction about documents is accepted in response to a user's operation to the operation unit 340. When the list display instruction is not accepted (N in step S110), the display processing unit 311 advances the processing to step S100. When the list display instruction is accepted (Y in step S110), the display processing unit 311 displays a list of all the documents stored in the document memory on the display unit 330 (step S112). When all the documents cannot be displayed on one screen, a list of the documents is displayed in such a way that all the documents are displayed in response to scrolling.

At this time, with respect to the document in the first state whose original image data is stored in the document memory, the display processing unit 311 renders the image of each page included in the document, based on the original image data, and thus displays each page of the document. Meanwhile, with respect to the data set in the second state whose original image data is not stored in the document memory, the display processing unit 311 renders the thumbnail data of each page and thus displays each page of the document. Thus, the page displayed based on the thumbnail data is an image having a lower resolution than the page displayed based on the original image data.

In this manner, the display processing unit 311 displays a plurality of pages included in the document in the first state on the display unit 330 based on the original image data, and displays a plurality of pages included in the document in the second state on the display unit 330, based on the thumbnail data of each page. The thumbnail data of the document in the second state is also stored and therefore can be displayed on the display unit 330 together with the document in the first state. Therefore, the user can easily grasp the content of the document in the second state.

In another example, the display processing unit 311 may also display each page of the document whose original image data is stored in the document memory, first based on the thumbnail data. In this case, the display processing unit 311 continuously renders the original image data, and on completion of the rendering, changes the display target image from an image based on the thumbnail data to an image based on the original image data. Thus, the display start timing can be made earlier.

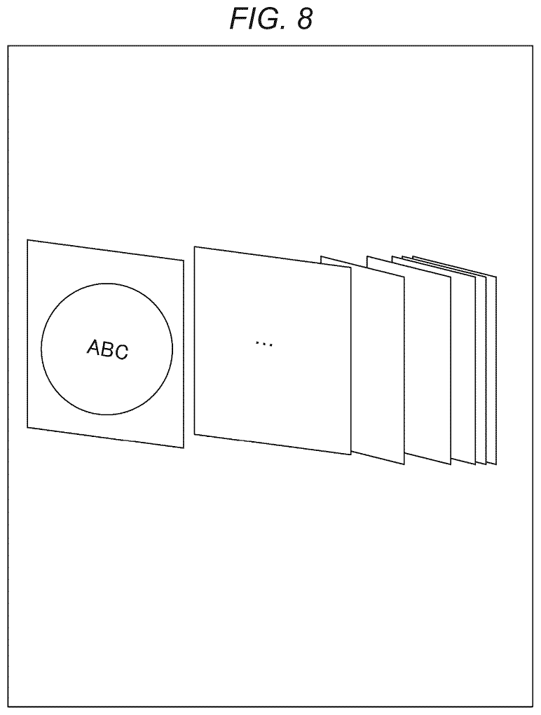

Next, when a document is selected in response to a user's operation (Y in step $114), the display processing unit 311 displays the selected document in an enlarged form (step S116) and subsequently advances the processing to step S100. For example, when the document at the top in FIG. 3 is selected, the document at the top is displayed in an enlarge form, as illustrated in FIG. 8. When a document is not selected (N in step S114), the display processing unit 311 advances the processing to step S100.

As illustrated in FIG. 6, in document enlargement processing, the data management unit 312 first checks the state of the selected document. When the selected document is in the second state (Y in step S200), the display processing unit 311 displays each page of the selected document in an enlarged form, based on the thumbnail data of the selected document stored in the document memory (step S202).

Next, the data management unit 312 shifts the state of the selected document from the second state to the first state (step S204). Specifically, the data management unit 312 updates the states of all the documents registered in the document memory in accordance with the estimation condition described with reference to FIG. 7. Thus, the state of the selected document shifts from the second state to the first state.

Next, the data management unit 312 acquires the original image data of the selected document from the display management server 20, and registers the original image data in the document memory (step S206). This processing is similar to the processing of step S108. At this time, when there is a document shifted from the second state to the first state other than the selected document, the data management unit 312 also acquires the original image data of such documents from the display management server 20. Also, when there is a document shifted from the first state to the second state, the data management unit 312 deletes the thumbnail data of such documents from the document memory.

Next, the display processing unit 311 renders the original image data of the selected document, and on completion of the rendering (Y in step S208), displays the rendered image as an enlarged display of the document (step S210). In this way, when the document in the second state is selected by the user, the display processing unit 311 displays each page of the document, based on the thumbnail data, until the original image data of the selected document is acquired from the display management server 20. After acquiring the original image data from the display management server 20, the display processing unit 311 displays each page of the document, based on the original image data.

When the selected document is in the first state (N in step S200), the data management unit 312 displays each page of the selected document in an enlarged form, based on the original image data of the selected document stored in the document memory (step S212).

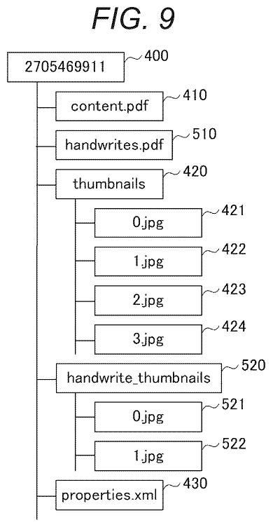

Next, a case where a hand-drawn image is drawn on a document by the user will be described. In this case, as an image to be superimposed on the original image, drawing image data representing a hand-drawn image drawn by the user is generated, and the drawing image data is added to the data set of the document. FIG. 9 shows the data structure of a data set of a document including drawing image data. The data set 400 includes drawing image data 510 in addition to the original image data 410. Also, the data set 400 includes a plurality of drawing thumbnail data 521 and 522 corresponding to the respective pages included in the drawing image data 510. Each of the drawing thumbnail data 521 and 522 is assigned a page number for identifying the corresponding page.

When the drawing image data is added to the data set, a data set including the drawing image data is transmitted to the display management server 20. Thus, the drawing image data is also stored in the display management server 20.

In this case, in the display processing, when the state of the document including the drawing image data shifts from the first state to the second state, the data management unit 312 deletes the drawing image data from the document memory while leaving the drawing thumbnail data. Also, when the state shifts from the second state to the first state, the data management unit 312 acquires the drawing image data from the display management server 20.

Also, when displaying the document in the first state, the display processing unit 311 displays the drawing added by the user to the page included in the document in the first state, in the form of being superimposed on the original image data, based on the drawing image data. Also, when displaying the document in the second state, the display processing unit 311 displays the drawing added by the user to the page included in the document in the second state, in the form of being superimposed on the thumbnail data, based on the drawing thumbnail data.

Moreover, while the hand-drawn image is displayed based on the drawing thumbnail data, the display processing unit 311 prohibits the drawing of a new hand-drawn image, and after the hand-drawn image is displayed based on the drawing image data, the drawings of a new hand-drawn image is enabled. When a new hand-drawn image is drawn, the data management unit 312 registers an image formed by superimposing the new hand-drawn image and the hand-drawn image drawn up to this point, in the data set as new drawing image data. That is, the data management unit 312 updates the drawing image data. Moreover, the data management unit 312 also updates the drawing thumbnail data in accordance with the update of the drawing image data.

As described above, in the display system 1 according to the present embodiment, the display device 30 can reduce the amount of data by deleting the original image data of the document in the second state. Thus, a plurality of documents can be stored. When the document in the second state is selected, the original image data of the selected document is acquired, and the document can be displayed, based on the original image data.

The foregoing embodiment is described by way of example to carry out the present disclosure, and various other embodiments can be employed.

In a first modification example as one of such embodiments, the estimation condition for determining the state of the document may be any condition such that the document that is highly likely to be viewed by the user is classified as the first state, and the specific condition to be employed is not limited to the condition described in the embodiment. For example, the estimation condition may be determined according to at least one of the timing of registration in the document memory and the timing of selection by the user, and the specific condition to be employed is not limited to the condition described in the embodiment. In another example, the estimation condition may be such that the document is included in five documents in order from the latest timing of selection and three documents in order from the latest timing of registration.

In still another example, the estimation condition may be a condition that the document displayed on the screen when the scrolling is stopped in the displayed list is selected as the first state, given priority over the document that is not displayed on the screen when the scrolling is stopped. Also, the estimation condition may be a condition that, when the list is displayed by scrolling, the document displayed on the screen is selected as the first state, given priority over the document that is not displayed on the screen.

In a second modification example, when deleting the original image data of the document in the second state, the data management unit 312 may leave, for example, the original image data of a part of the pages of the document such as the first page of the document in the document memory. In this case, when displaying the document in the second state, the display processing unit 311 displays the page whose original image data is stored in the document memory, based on the original image data. The display processing unit 311 displays the page whose original image data is not stored in the document memory, based on the thumbnail data. Thus, a specific page such as the first page, which is highly likely to be viewed by the user, can be displayed with a higher resolution.

A third modification example will be described. In the present embodiment, the display device 30 receives a document as a data set in the state of including thumbnail data, but it is also conceivable that the display device 30 acquires only the original image data of the document and that the data set does not include thumbnail data. In this case, when the document shifts from the first state to the second state, the data management unit 312 generates thumbnail data of each page of the shifted document and stores the thumbnail data in the document memory. Then, the data management unit 312 deletes the original image data of the document from the document memory. Thus, a document for which thumbnail data is not acquired can be similarly managed with the amount of data reduced.

In a fourth modification example, a third state may be managed in addition to the first state and the second state as the state of the document. In this case, it is assumed that a first estimation condition for determining the first state and a second estimation condition for determining the second state are set in advance. The first estimation condition is similar to the estimation condition described in the embodiment. Then, it is assumed that the second estimation condition is a condition such that a document that is next most likely to be viewed by the user after the document in the first state is classified as the second state. For example, the second estimation condition is a condition that the document is a document that does not satisfy the first estimation condition, among documents included in the top 30 documents selected alternately from documents registered in the document memory at recent timings and documents selected by the user at recent timings. When the document in the third state is selected by the user, the selected document shifts from the third state to the first state.

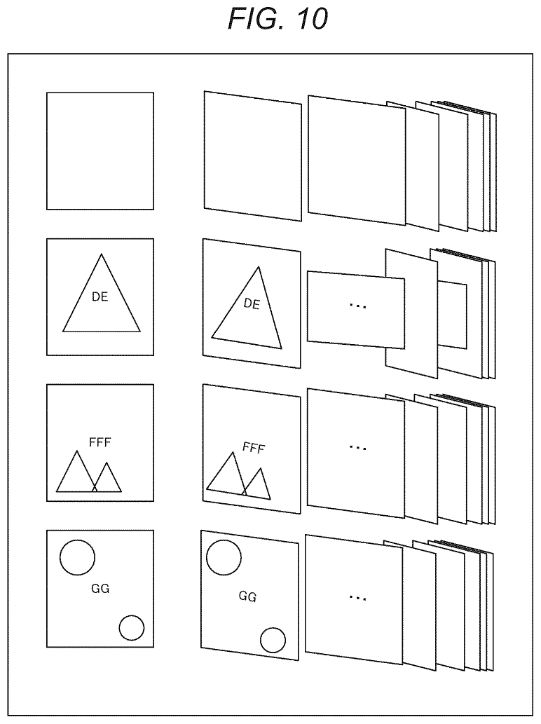

The data management unit 312 deletes the original image data and the thumbnail data of the document in the third state while leaving the metadata. Thus, the amount of data stored in the display device 30 can be further reduced. The display processing unit 311 displays a plurality of pages of the document in the third state, based on the metadata indicating features of the plurality of pages of the document. Since the metadata includes the shape of each page, a blank page is displayed in the shape indicated by the metadata, in the display of the list. In the example illustrated in FIG. 10, a document in the third state, that is, a document corresponding to the metadata, is displayed at the top part.

When the document in the third state is selected by the user, the display processing unit 311 first displays a blank page in an enlarged form, based on the shape and the number of pages indicated by the metadata of the selected document. Then, the display processing unit 311 acquires the thumbnail data and the original image data of the selected document from the display management server 20. On completion of the rendering of the thumbnail data, the display processing unit 311 performs the enlarged display of the page of the document, based on the thumbnail data, and subsequently, on completion of the rendering of the original image data, the display processing unit 311 performs the enlarged display of the page of the document, based on the original image. As described above, even in the case of a blank page, the shape and the number of pages are displayed, and therefore the user can grasp the outline of the document.

In another example, the display processing unit 311 may display a blank page without performing the display based on the thumbnail data, and on completion of the rendering of the original image data, the display processing unit 311 may display each page in an enlarged form, based on the original image.

The foregoing embodiments are described by way of example to carry out the present disclosure, and various other embodiments can be employed. Various modifications and changes can be made without departing from the spirit and scope of the present disclosure described in the claims, for example, applying a modification example of one embodiment to another embodiment, or the like.

The thumbnail data may be data of an image formed by reducing the amount of data from general original image data. The number of pixels of the thumbnail data may be fixed to be a smaller number of pixels than the original image, or may be the number of pixels determined dynamically based on the screen size of the display device or the like. The thumbnail data may also be data of an image formed by reducing the number of tones and thus reducing the amount of data.

The selection of a document in the present application refers to at least an operation to display the document in an enlarged form, and may not include operations for other purposes. For example, when an operation to delete the document in the second state is performed, this operation is not regarded as the selection of the document, and therefore the document may not be shifted to the first state and may be deleted while still in the second state.

The present disclosure can also be applied as a program executed by a computer or as a method. Also, the present disclosure may be implemented as a single device as described above or may be implemented using components of a plurality of devices, and may include various aspects. Also, suitable changes can be made, such as a part being software and a part being hardware. Moreover, the present disclosure can be applied as a recording medium of a program that controls the system. Of course, the recording medium of the program may be a magnetic recording medium or a semiconductor memory, and any recording medium to be developed in the future can be similarly considered. The present disclosure may also be applied as a printer driver or an application that executes a part or all of the processing in the foregoing flowchart.

What is claimed is:

1. A non-transitory computer-readable storage medium storing a program, the program causing a computer to function as;
a display processing unit that displays a plurality of pages included in a document in a first state on a display unit, based on original image data, and displays a plurality of pages included in a document in a second state on the display unit, based on reduced image data of each page; and
a data management unit that, when a document present in a storage unit shifts from the first state to the second state, deletes the original image data of the shifted document from the storage unit while leaving the reduced image data of each page of the shifted document, and when the document present in the storage unit shifts from the second state to the first state, acquires the original image data of the shifted document from an external device.

2. The storage medium according to claim 1, wherein the display processing unit displays a plurality of pages included in the document in the first state and a plurality of pages included in the document in the second state side by side.

3. The storage medium according to claim 1, wherein the display processing unit displays a document selected by a user in an enlarged form, and
when the document in the second state is selected by a user, the selected document shifts from the second state to the first state.

4. The storage medium according to claim 3, wherein, when the document in the second state is selected by the user, the display processing unit displays the page of the selected document based on the reduced image data until the original image data of the selected document is acquired from the external device, and displays the page of the selected document based on the acquired original image data after acquiring the original image data of the selected document from the external device.

5. The storage medium according to claim 1, wherein when the document shifts from the first state to the second state, the data management unit generates the reduced image data of the shifted document and then deletes the original image data of the shifted document from the storage unit.

6. The storage medium according to claim 1, wherein the data management unit stores the original image data and the reduced image data of the document in the storage unit and thus registers the document.

7. The storage medium according to claim 1, wherein, when deleting the original image data of the document shifted to the second state, the data management unit leaves the original image data of a part of pages of the document in the storage unit, and
when displaying the document in the second state, the display processing unit displays a page whose original image data is stored in the storage unit, based on the original image data, and displays a page whose original image data is not stored in the storage unit, based on the reduced image data.

8. The storage medium according to claim 1, wherein, based on metadata indicating characteristics of a plurality of pages included in a document in a third state, the display processing unit displays the plurality of pages included in the document in the third state, and
the data management unit stores the metadata of the document in the third state in the storage unit, and does not store the original image data and the reduced image data of the document in the third state in the storage unit.

9. The storage medium according to claim 8, wherein when the document in the third state is selected by a user, the selected document shifts from the third state to the first state.

10. The storage medium according to claim 8, wherein, when the document in the third state is selected by a user, the display processing unit displays a blank page of the selected document until the reduced image data is acquired from the external device, displays the page of the selected document based on the reduced image data after acquiring the reduced image data from the external device, and displays the page of the selected document based on the original image data after acquiring the original image data from the external device.

11. The storage medium according to claim 1, wherein the display processing unit displays a page designated by metadata of the document in the first state on the display unit by superimposing the image represented by the original image data and a tag image, and displays a page designated by metadata of the document in the second state on the display unit by superimposing the image represented by the reduced image data and a tag image.

12. The storage medium according to claim 1, wherein the display processing unit displays a page designated by metadata of the document in the first state on the display unit by shifting the image represented by the original image data from a position of images of other pages, and displays a page designated by metadata of the document in the second state on the display unit by shifting the image represented by the reduced image data from a position of images of other pages.

13. The storage medium according to claim 1, wherein the display processing unit displays a drawing added by a user to a page included in the document in the first state, based on drawing image data, and displays a drawing added by the user to a page included in the document in the second state, based on drawing reduced image data.

14. A display device comprising;
a processor that causes a display unit to display a plurality of pages included in a document in a first state, based on original image data, and causes the display unit to display a plurality of pages included in a document in a second state, based on reduced image data;
a communication unit that, in response to a shift of the document from the second state to the first state, acquires original image data of the shifted document from an external device; and
a storage unit that stores the original image data of the document in the first state and the reduced image data of each page of the document in the second state and does not store the original image data of the document in the second state, wherein
the storage unit stores the original image data of the shifted document when the document shifts from the second state to the first state, and deletes the original image data of the shifted document when the document shifts from the first state to the second state.

15. A display method comprising;
causing a display unit to display a plurality of pages included in a document in a first state, based on original image data;
causing the display unit to display a plurality of pages included in a document in a second state, based on reduced image data of each page;
when the document shifts from the first state to the second state, deleting the original image data of the shifted document from the storage unit while leaving the reduced image data of each page of the shifted document; and
when the document shifts from the second state to the first state, causing the storage unit to store the original image data of the shifted document.
